(19) United States
(12) Patent Application Publication
(10) Pub. No.: US 2017/0022030 A1
(43) Pub. Date: Jan. 26, 2017

(54) LIMITING MECHANISM FOR AN ELEVATOR COMPENSATION ROPE TENSIONING PULLEY, AN ELEVATOR COMPENSATION APPARATUS, AND AN ELEVATOR SYSTEM

(71) Applicant: Otis Elevator Company, Farmington, CT (US)

(72) Inventors: Hebin Bai, Tianjin (CN); Zhixue Li, Tianjin (CN)

(21) Appl. No.: 15/216,202

(22) Filed: Jul. 21, 2016

(30) Foreign Application Priority Data
Jul. 23, 2015 (CN) CN201510436233.0

(51) Int. Cl. B66B 7/06

(52) U.S. Cl. CPC B66B 7/068

(57) ABSTRACT

A limiting mechanism for an elevator compensation rope tensioning pulley, an elevator compensation apparatus including the limiting mechanism for an elevator compensation rope tensioning pulley, and an elevator system. The limiting mechanism for an elevator compensation rope tensioning pulley includes: a first limiting component, disposed on a frame of an elevator compensation rope tensioning pulley, and kept in position by a tensioning force of an elevator compensation rope together with the elevator compensation rope tensioning pulley and the frame; and a second limiting component, limited at a suitable position relative to a guiderail of the elevator compensation rope tensioning pulley, wherein a vertical distance within a predetermined range is kept between the first limiting component and the second limiting component, and, when an upward displacement of the elevator compensation rope tensioning pulley reaches the vertical distance, the first limiting component collides with the second limiting component.

### PRIORITY

This application claims priority to Chinese Patent Application No. 201510436233.0, filed Jul. 23, 2015, and all the benefits accruing therefrom under 35 U.S.C. §119, the contents of which in its entirety are herein incorporated by reference.

### TECHNICAL FIELD

The present invention relates to the field of elevator technologies, and more particularly, the present invention relates to a limiting mechanism for an elevator compensation rope tensioning pulley, and further relates to an elevator compensation apparatus and an elevator system including the limiting mechanism for an elevator compensation rope tensioning pulley.

### BACKGROUND

There are various common types of elevator systems in the prior art. A common one is a traction-type elevator system. Such a system includes a tractor, a traction rope, a car, a counterweight, and a corresponding control system, and the like. An end of the traction rope is connected to the car by using a traction pulley on the tractor, and the other end of the traction rope is connected to the counterweight. The tractor drives the traction rope by using a frictional force between the traction rope and the traction pulley, to further pull the car and the counterweight to make relative movements.

To compensate for the weight of the traction rope and the weight of other components to enable an elevator to operate stably, a compensation apparatus usually needs to be installed for the elevator system. For an elevator that has a relatively low elevation height and speed, a compensation chain is usually used for compensation. For an elevator that has a relatively high height and speed, a compensation rope is usually used for compensation. A compensation rope compensation apparatus usually includes a compensation rope and a compensation rope tensioning pulley, wherein the compensation rope is wound around the tensioning pulley, two ends of the compensation rope are respectively connected to the bottom of the car and the bottom of the counterweight, and the tensioning pulley is installed in a pit of an elevator shaft by using a guiderail of the tensioning pulley. When the compensation rope contracts because, for example, a temperature changes, the compensation rope tensioning pulley and a frame of the compensation rope tensioning pulley can slide vertically within a particular range along the guiderail of the tensioning pulley, to enable the compensation rope to keep a tensioned state.

For a safety consideration, the compensation apparatus usually includes a tensioning pulley limiting mechanism located on the compensation rope tensioning pulley, and the tensioning pulley limiting mechanism allows the tensioning pulley to move within a set range (for example, when the compensation rope expands or contracts due to the weather), but limits a sudden significant upward rush of the tensioning pulley (for example, when an elevator car stops suddenly or a safety clamp acts).

A tensioning pulley limiting mechanism in the prior art includes a hydraulic limiting mechanism, a wedge-type limiting mechanism, and the like. These limiting mechanisms in the prior art have complex structures, high costs, and troublesome installation and maintenance.

### SUMMARY

An objective of the present invention is to provide a limiting mechanism for an elevator compensation rope tensioning pulley that overcomes the foregoing defects in the prior art.

Another objective of the present invention is to provide an elevator compensation apparatus and an elevator system including the foregoing limiting mechanism for an elevator compensation rope tensioning pulley.

According to a first aspect of the present invention, a limiting mechanism for an elevator compensation rope tensioning pulley is provided, wherein the limiting mechanism includes:

a first limiting component, disposed on a frame of an elevator compensation rope tensioning pulley, and kept in position by a tensioning force of an elevator compensation rope together with the elevator compensation rope tensioning pulley and the frame; and

a second limiting component, limited at a suitable position relative to a guiderail of the elevator compensation rope tensioning pulley,

wherein a vertical distance within a predetermined range is kept between the first limiting component and the second limiting component, and, when an upward displacement of the elevator compensation rope tensioning pulley reaches the vertical distance, the first limiting component collides with the second limiting component to limit the elevator compensation rope tensioning pulley to make the elevator compensation rope tensioning pulley stop moving upward.

According to a second aspect of the present invention, an elevator compensation apparatus is provided, wherein the elevator compensation apparatus includes an elevator compensation rope and an elevator compensation rope tensioning pulley, and the elevator compensation rope tensioning pulley is installed inside a frame of the elevator compensation rope tensioning pulley, and

the elevator compensation apparatus further includes the limiting mechanism for an elevator compensation rope tensioning pulley according to the foregoing first aspect.

According to a third aspect of the present invention, an elevator system is provided, wherein the elevator system includes the elevator compensation apparatus according to the foregoing second aspect.

### BRIEF DESCRIPTION OF THE DRAWINGS

Referring to the accompanying drawings and the detailed description in the following, the disclosed contents of the present invention and the foregoing and other objectives and advantages of the present invention will become more thorough and clearer. In the drawings, the like components are represented by the like reference numerals, and these accompanying drawings are only used for the purpose of description, rather than to limit the protection scope of the present invention.

It may be understood that to make the accompanying drawings more clearer and to make the description more concise, not all components of an elevator system are shown in the accompanying drawings, and instead multiple components that need to be understood by a person skilled in the art to completely implement the present invention are shown. For a person skilled in the art, operations of many components are well known and obvious.

In the drawings:

FIG. 1 is a schematic view of an embodiment of an elevator compensation apparatus according to the present invention;

FIG. 2 is a schematic view of an embodiment of a limiting mechanism for an elevator compensation rope tensioning pulley according to the present invention;

FIG. 3 is a schematic partially enlarged view of a pawl assembly in a limiting mechanism for an elevator compensation rope tensioning pulley according to the present invention;

FIG. 4 is a schematic partial view of the limiting mechanism for an elevator compensation rope tensioning pulley according to the present invention shown in FIG. 2;

FIG. 5 is a schematic sectional view of an spacing washer sleeved inside a second limiting component in the limiting mechanism for an elevator compensation rope tensioning pulley shown in FIG. 2;

FIG. 6 is a schematic view of the limiting mechanism for an elevator compensation rope tensioning pulley shown in FIG. 2 being in a collided state; and

FIG. 7 is a schematic view of another embodiment of an elevator compensation apparatus according to the present invention.

### DETAILED DESCRIPTION

Some of multiple possible embodiments of the present invention are introduced below, and are intended to provide basic understanding about the present invention, but are not intended to confirm critical or decisive features of the present invention or to limit the protection scope. It may be easily understood that according to the technical solutions of the present invention, without changing the basic principle of the present invention, a person skilled in the art may propose other interchangeable embodiments. Therefore, the following specific embodiments are merely exemplary description of the technical solutions of the present invention, and should not be regarded as the whole of the present invention or regarded as limitations to the technical solutions of the present invention.

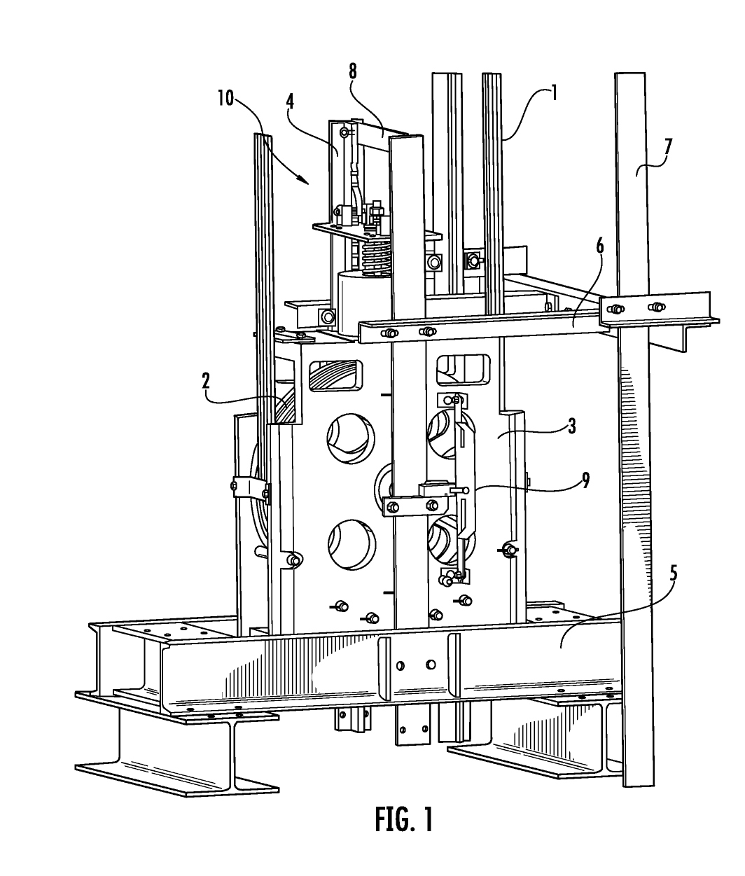

FIG. 1 is a schematic view of an embodiment of an elevator compensation apparatus according to the present invention.

As can be seen from FIG. 1, the elevator compensation apparatus in FIG. 1 includes a compensation rope 1 and a compensation rope tensioning pulley 2. The compensation rope 1 is wound around below the tensioning pulley 2. Several position-limiting grooves are formed on an outer peripheral surface of the tensioning pulley 2. The compensation rope 1 is joined inside these position-limiting grooves. To prevent an elevator compensation rope to jump off from the grooves, on two sides of a frame 3, a rope blocking plate, a rope blocking shaft, and the like are disposed on a radial outer side of a circumferential surface of the tensioning pulley 2, so as to prevent a radial runout of the compensation rope.

A person skilled in the art may understand that two ends of the compensation rope 1 may be respectively connected to the bottoms of an elevator car (not shown) and an elevator counterweight (not shown). In this way, the elevator compensation rope 1 and the elevator traction rope (not shown) pass through the elevator car and the counterweight to form a rope ring, thereby reducing the load of an elevator driving mechanism, and when the elevator works and reciprocates, a weight imbalance between a side of the car and a side of the counterweight is avoided. To keep the tension between the compensation rope and the traction rope, the tensioning pulley 2 is suspended at the bottom of an elevator shaft way by using the compensation rope, and pulls the compensation rope 1 downward under the effect of the gravity. A person skilled in the art may conceive that a counterweight block is used to adjust the tension of a rope.

According to a compensation rate of a system, there may be one or more compensation ropes. Multiple compensation ropes are more common in actual applications. In an example in the drawings of the present invention, there may be five compensation ropes. It may be understood that a person skilled in the art may select the quantity of compensation ropes according to a specific case, so as to implement more desirable working performance of an elevator system, especially, an elevator compensation apparatus.

It should be understood that the compensation rope, the traction rope, and the like involved in the embodiments of the present invention include a common rope, a chain, a belt, and the like in the technical field, for example, a compensation chain, and a compensation belt.

The compensation rope tensioning pulley 2 is installed on a guiderail 4 by using the frame 3. Specifically, in this embodiment, the tensioning pulley 2 is received in the frame 3. The frame 3 may have an effect of protecting the tensioning pulley 2, and can prevent the tensioning pulley 2 from being polluted for a reason such as dust or a foreign object. It may be understood that the weight of the tensioning pulley frame 3 also helps to provide a tensioning effect to the compensation rope 1. As discussed above, to improve the tensioning effect by adjusting the tension of the compensation rope 1, or to increase the stability and reliability of the tensioning pulley 2 and the frame 3 in a working process, a person skilled in the art may conceive that another counterweight block (not shown) is added to the tensioning pulley frame 3, and the counterweight block is movable together with the tensioning pulley and the frame. The counterweight block may be added on the top of the tensioning pulley frame 3 or symmetrically added on two sides of the frame 3.

To ensure the lateral stability of the compensation rope tensioning pulley 2 and the frame 3 during the vertical movement, the tensioning pulley guiderail 4 is installed in a pit of the elevator shaft way, so as to provide guidance to the tensioning pulley frame 3, for the tensioning pulley frame 3 to slide along the guiderail 4. The guiderail 4 guides the tensioning pulley and the frame to move upward and downward, to prevent the tensioning pulley and the frame from undesired sway. A reinforcing support 8 is optionally installed on a top end of the guiderail 4, and is used to increase the strength of the tensioning pulley guiderail 4, thereby preventing the guiderail from shaking. The guiderail 4 may be directly fixed in the pit of the elevator shaft way, or may be fixed to the elevator compensation apparatus base 5 to be indirectly fixed in the pit of the elevator shaft way, or the guiderail 4 is directly fixed in the pit of the elevator shaft way and at the same time is further fixed to the elevator compensation apparatus base 5 to be fixed in the pit of the elevator shaft way.

The elevator compensation apparatus base 5 implements support for the entire elevator compensation apparatus. The elevator compensation apparatus base 5 occupies a larger area, and can further improve the lateral stability of the guiderail 4 and the entire elevator compensation apparatus. Molding materials, for example, I-shaped steel materials and aluminum material that are welded or screwed together, may be selected for the elevator compensation apparatus base 5.

To increase the installation stability of the guiderail 4, in an optional example, as shown in the figure, a guiderail support 6 may be further disposed additionally. The guiderail support 6 may be supported between the tensioning pulley guiderail 4 and the elevator counterweight guiderail 7 at a suitable height in a transverse direction, and the guiderail 4 is fixed to the elevator counterweight guiderail 7, so as to provide a further lateral support to the tensioning pulley guiderail 4.

As mentioned above, the length of an elevator compensation rope 2 may change at different air temperatures because of thermal expansion. In addition, after a long time use of the elevator compensation rope, the compensation rope may also be tensioned longer because of tension. When the compensation rope shortens to a certain degree, the tensioning pulley frame 3 may be elevated to make a spring compress excessively, which causes excessive tension to occur between the compensation rope and the traction rope, resulting in excessive load on the operation of an elevator system. When the compensation rope is extended to a certain degree, the tensioning pulley frame 3 may directly contact a ground surface of the pit of the elevator shaft way, which diminishes or even eliminates a tensioning effect of the tensioning pulley 2 on the compensation rope 1. These cases are all undesired and may cause danger to the operation of the elevator. For this reason, a position-limiting mechanism 9 is disposed in the shown elevator compensation apparatus of the present invention. The position-limiting mechanism 9 includes a position-limiting switch located on the guiderail 4 and a position-limiting switch touch plate fixed on a side of the tensioning pulley frame 3. The position-limiting switch is located at a position at a fixed height on the guiderail 4. When the position-limiting switch touch plate moves upward and downward along with the tensioning pulley frame 3 because of the expansion and contraction of the compensation rope and reaches a limiting position, according to a case, portions that protrude from two ends of the position-limiting switch touch plate toward the position-limiting switch may trigger the position-limiting switch, to stop the elevator system and send an alarm to a maintenance person. After the maintenance person makes a suitable adjustment to the length of the elevator compensation rope 1 according to the alarm, an elevator compensation rope tensioning pulley and a frame of the elevator compensation rope tensioning pulley are located at desired working heights, so that the normal operation of the elevator system is restored.

When the elevator stops suddenly or a safety clamp brakes the elevator, the car or the counterweight may continue moving upward under the effect of inertia, which causes the tensioning pulley to rush upward rapidly, further causing the elevator to shake or causing a safety hazard, or even causing that the compensation rope tensioning pulley jumps off from the tensioning pulley guiderail 4. To prevent such a case from occurring, a limiting mechanism for an elevator compensation rope tensioning pulley is further disposed in the elevator compensation apparatus of the present invention. The limiting mechanism includes a first limiting component disposed on the frame of the elevator compensation rope tensioning pulley. The limiting mechanism, the elevator compensation rope tensioning pulley, and the frame are kept in position by means of a tensioning force of the elevator compensation rope. The elevator compensation apparatus further includes a second limiting component limited at a suitable position relative to the guiderail of the elevator compensation rope tensioning pulley. A vertical distance within a predetermined range is kept between the first limiting component and the second limiting component, and, when an upward displacement of the elevator compensation rope tensioning pulley reaches the vertical distance, the first limiting component collides with the second limiting component to limit the elevator compensation rope tensioning pulley to make the elevator compensation rope tensioning pulley stop moving upward.

In an embodiment of the elevator compensation apparatus of the present invention shown in FIG. 1, a limiting mechanism 10, that is, the portion in the circle in FIG. 1, is disposed on the top of the elevator compensation rope the tensioning pulley frame 3. The limiting mechanism 10 can effectively prevent sudden upward rush of the elevator compensation rope tensioning pulley. The limiting mechanism 10 in the elevator compensation apparatus in FIG. 1 is exemplary and descriptive.

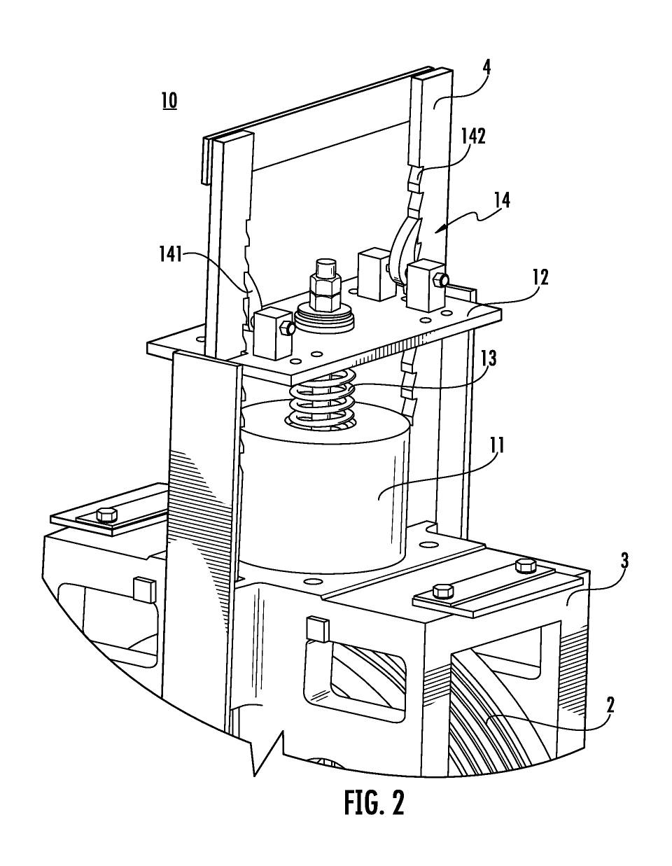

FIG. 2 is a schematic view of an embodiment of a limiting mechanism for an elevator compensation rope tensioning pulley according to the present invention. FIG. 2 shows the limiting mechanism in the elevator compensation apparatus in FIG. 1 more clearly from another angle.

As can be seen from the FIG., a limiting mechanism 10 shown in the FIG. includes a pad block, for example, a rubber pad 11, used as a first limiting component, and a rigid fixing plate 12 used as a second limiting component. A spring 13 keeps a predetermined distance in a longitudinal direction between the rubber pad and the fixing plate. A pawl assembly locks a ratchet rack on a guiderail 4, thereby preventing the fixing plate 12 from moving upward along the guiderail.

The rubber pad 11 is located on a tensioning pulley frame 3. The rubber pad 11, a tensioning pulley 2, and the frame 3 are kept in position by means of a tensioning force of an elevator compensation rope 1, that is, suspended on the compensation rope. When the tensioning pulley 2 and the frame 3 rush upward, the rubber pad 11 collides with the fixing plate 12, and the elasticity of the rubber pad 11 can exert an effect of cushioning the collision. To make positioning more stable, it may be conceived to fix the rubber pad 11 to the frame 3 by using a bolt or another conventional manner. In addition, in consideration of the limitation of a transverse area of the elevator shaft way, the rubber pad 11 shown in FIG. 2 is optionally positioned at the top of the frame 3 and is located between two guiderails 4. This also achieves the objectives of a simple structure and simple operations. It may be conceived that in an optional embodiment, the rubber pad may also be disposed at another suitable position, corresponding to the fixing plate 12, on the frame 3. The suitable position is, for example, but is not limited to, an outer side of the guiderail 4 and the like.

A collision contact area, a thickness, an elasticity, and the like of the rubber pad 11 all affect the working performance of the limiting mechanism 10. Therefore, in a feasible case, it is suitable to select a relatively large collision contact area and relatively large thickness; and it is suitable to determine the elasticity of the rubber pad 11 by using design parameters of an elevator and corresponding experiments, and a person skilled in the art may make a choice according to a specific case under the teaching of the present invention. In an optional embodiment, it may be further conceived to design concave and convex features or patterns on an upper surface of the rubber pad 11 to improve collision cushioning performance of the rubber pad 11. Therefore, according to the instruction of the present invention, a person skilled in the art can select attributes such as the collision contact area, the thickness, and the elasticity of the rubber pad 11 that are suitable for cushioning the impact when the rubber pad 11 collides with the fixing plate 12. The rubber pad 11 may have a columnar shape, and optionally have a prismatic shape or a cylindrical shape that is shown in the drawing.

In this embodiment, a solution in which the rubber pad is used as the first limiting component is exemplary. It may be understood that a person skilled in the art may think of using a first limiting component and a second limiting component that are both rigid. However, on at least one of the limiting components, at least at a position where the first limiting component and the second limiting component are to collide, an elastic cushioning material may be disposed to cushion the collision between the first limiting component and the second limiting component. A rubber material may also be used for the elastic cushioning material. It may be conceived that in an extreme embodiment, the tensioning pulley frame 3 itself may be used as the first limiting component (that is, a limiting component integrated with the tensioning pulley frame 3). When the first limiting component collides with the second limiting component (for example, a fixing plate), the upward rush of the tensioning pulley is limited. In this case, a suitable elastic cushioning material may be disposed on at least one of the tensioning pulley frame 3 and the fixing plate 12 to cushion the collision between the first limiting component and the second limiting component. For the selection of the elastic cushioning material, reference may be made to the foregoing description of the rubber pad 11. It may be understood that this extreme embodiment may also be included in the protection scope of the present invention.

The fixing plate 12 is located above the rubber pad, and is kept by the spring 13 at a predetermined distance from the rubber pad 11. When the tensioning pulley 2 moves downward, the fixing plate 12 moves downward because of gravity, and a pawl (referring to the following description) slides over a tooth back of a ratchet on the ratchet rack. In this case, the spring 13 can keep a vertical distance between the rubber pad 11 and the fixing plate 12 unchanged. It may be seen that by adjusting the length of the compensation rope 1 or a compression amount of the spring 13, a limiting position of the fixing plate 12 on the guiderail 4 can be adjusted. Once the position of the fixing plate 12 is determined, when the pawl moves upward, the pawl fits with a first ratchet above the pawl and is locked on the ratchet rack, and therefore, the upward movement of the tensioning pulley 2 can only be within a range of the predetermined distance between the rubber pad 11 and the fixing plate 12.

As shown in the FIG., two pawl assemblies 14 are disposed on the fixing plate 12. The pawl assembly 14 is joined with the ratchet rack on the guiderail 4, which limits the upward movement of the fixing plate along the guiderail 4. The pawl assembly 14 includes a pawl 141 whose end is upward, a ratchet rack 142 is formed on a lateral portion of the guiderail 4, and the pawl 141 is biased on a tooth back of the ratchet on the ratchet rack. When the fixing plate tends to move upward, the pawl 141 is joined with the ratchet to lock the fixing plate 12 in position. It may be seen that once the tensioning pulley 2 and the frame 3 rush upward, the rubber pad 11 overcomes a frictional force of the spring 13 to collide with the fixing plate 12. The fixing plate 12 stops the tensioning pulley 2, the frame 3, and the rubber pad 11 from rushing upward.

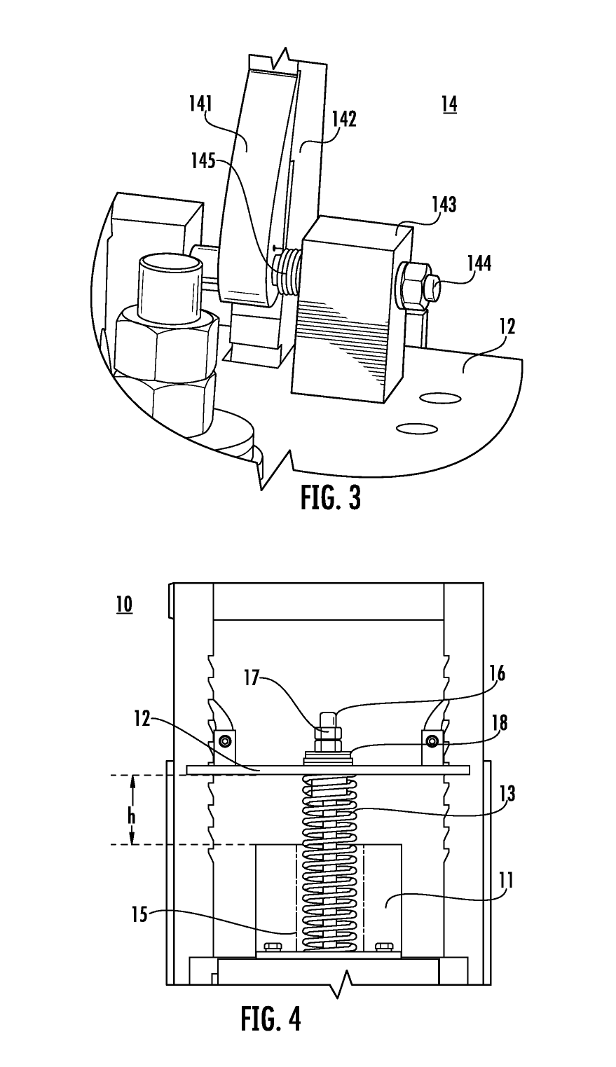

FIG. 3 is a schematic partially enlarged view of a pawl assembly in a limiting mechanism for an elevator compensation rope tensioning pulley according to the present invention. As can be seen from FIG. 3, in addition to the foregoing components, a pawl assembly 14 further includes a pawl base 143, a pivot shaft 144, and a torsion spring 145. Two pawl bases 143 are fixed on a fixing plate 12, and the pivot shaft 144 is transversely mounted between the two pawl bases 143. A pawl 141 is sleeved over on the pivot shaft 144 between the two pawl bases 143 in a pivotal manner. To implement that the pawl is joined with a ratchet rack to implement the function of the pawl assembly, the torsion spring 145 is sheathed on the pivot shaft and the torsion spring 145 biases the pawl 141 on a tooth back of a ratchet rack 142, to provide a torque to the pawl to ensure that the pawl stays tightly joined to a ratchet. In FIG. 2, there are two pawl bases 143, and the two pawl bases 143 are respectively located on two sides of the pawl. The quantity and positions of the pawls may correspond to the quantity and positions of the ratchet racks on the guiderail. In this embodiment, the quantity of the pawls is two. A person skilled in the art may design different quantities of guiderails, ratchets, and pawls according to a specific case of the elevator without being limited to the example here, and details are no longer described herein. Undoubtedly, these variations also fall within the scope of the present invention.

FIG. 4 is a schematic partial view of the limiting mechanism for an elevator compensation rope tensioning pulley according to the present invention shown in FIG. 2. As can be clearly seen from FIG. 4, the bottom of the rubber pad 11 is optionally fixed on a tensioning pulley frame 3 by using a bolt. A compression spring 13 is located between the tensioning pulley frame 3 and the fixing plate 12, and passes through a through hole 15 at an intermediate portion of the rubber pad 11, and the through hole 15 further helps to provide the spring 13 with an effect of external guidance, thereby helping to increase the lateral stability of the spring.

A lead screw 16 is vertically disposed inside the compression the spring 13. A lower end of the lead screw 16 is fixed on the tensioning pulley frame 3, and an upper end of the lead screw 16 extends and passes through the fixing plate 12. An adjusting nut 17 located above the fixing plate 12 is disposed at the upper end of the lead screw 16. By means of the cooperation between the compression the spring 13 and the adjusting nut 17, a vertical distance h within a predetermined range is kept between the rubber pad 11 and the fixing plate 12. When an upward displacement of an elevator compensation rope tensioning pulley 2 reaches h, the rubber pad 11 collides with the fixing plate 12 and limits the upward movement of the tensioning pulley 2.

An upper end and a lower end of a coil spring 13 are respectively held against the fixing plate 12 and the tensioning pulley frame 3, and can both exert a distance keeping effect and a collision cushioning effect. When the tensioning pulley frame 3 and the rubber pad 11 move upward, the kept distance is compressed, until the rubber pad 11 collides with the fixing plate 12. It may be understood that in a basic limiting mechanism, an adjusting nut on a lead screw may be not disposed. In a case in which an adjusting nut is not disposed, the elasticity of the spring should be sufficient to keep the predetermined distance between the fixing plate and the rubber pad, and the kept distance depends on the original length of the spring in the apparatus. In a case in which the adjusting nut 17 is disposed, the adjusting nut 17 is held downward against the fixing plate. Therefore, the adjusting nut 17 may be adjusted in a longitudinal direction of the lead screw 16 to enable the compression spring 13 to implement a different distance to be kept. The adjusting nut 17 shown in FIG. 2 includes two superimposed nuts to prevent the adjusting nut 17 from becoming loose.

Although not shown in the FIG., a person skilled in the art may further understand that above the adjusting nut 17, a cotter pin may be further disposed in the lead screw 16 in a traversed manner, and the cotter pin can prevent the upward movement along the lead screw 16, thereby preventing the adjusting nut 17 from becoming loose.

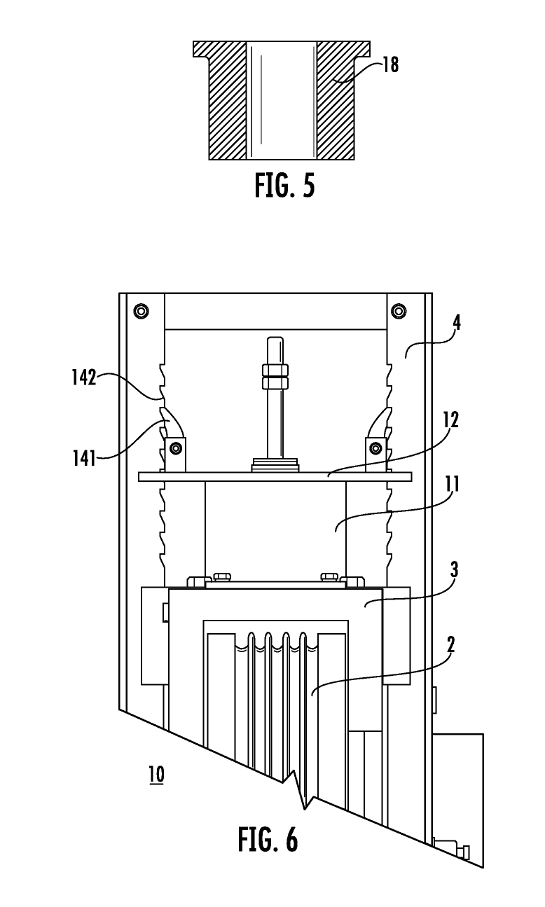

The lead screw 16 inside the coil spring 13 can exert an effect of providing the spring with internal guidance. A penetrating hole (not shown) corresponding to the lead screw 16 is disposed in the fixing plate 12, and the lead screw 16 extends and passes through the penetrating hole and is slidable longitudinally relative to the penetrating hole. Optionally, a spacing washer 18 for keeping the lead screw 12 and the fixing plate from direct contact may be sleeved inside the penetrating hole. FIG. 5 is a schematic sectional view of the spacing washer 18 sleeved inside the fixing plate 12 in the limiting mechanism for an elevator compensation rope tensioning pulley 10 shown in FIG. 2. The spacing washer 18 is optionally a rubber washer, a through hole of which is suitable for the lead screw 16 to pass through. A portion with a flange at a top end of the spacing washer 18 is suitable for being padded between the adjusting nut 17 and the fixing plate 12. A body portion of a rubber washer 18 may extend along the thickness of the fixing plate 12, so as to completely isolate the lead screw 16 from the fixing plate 12, to prevent the lead screw 16 and the fixing plate 12 from contacting each other, so as to attempt to eliminate the friction, collision, noise, and the like between the lead screw 16 from the fixing plate 12.

To implement the same or even more desirable effect, a hydraulic cylinder (not shown) may be chosen to replace the spring 13, the lead screw 16, and the adjusting nut 17 in the shown embodiment. In such a case, a cylinder block of the hydraulic cylinder may be fixed to the tensioning pulley frame 3, and a piston of the hydraulic cylinder may be fixed to the fixing plate 12. Furthermore, if a suitable elasticity of the rubber pad is selected and the elastic rubber pad can independently achieve collision cushioning, another distance keeping component that does not have a cushioning function may also be selected to replace the spring 13. Details are no longer described herein.

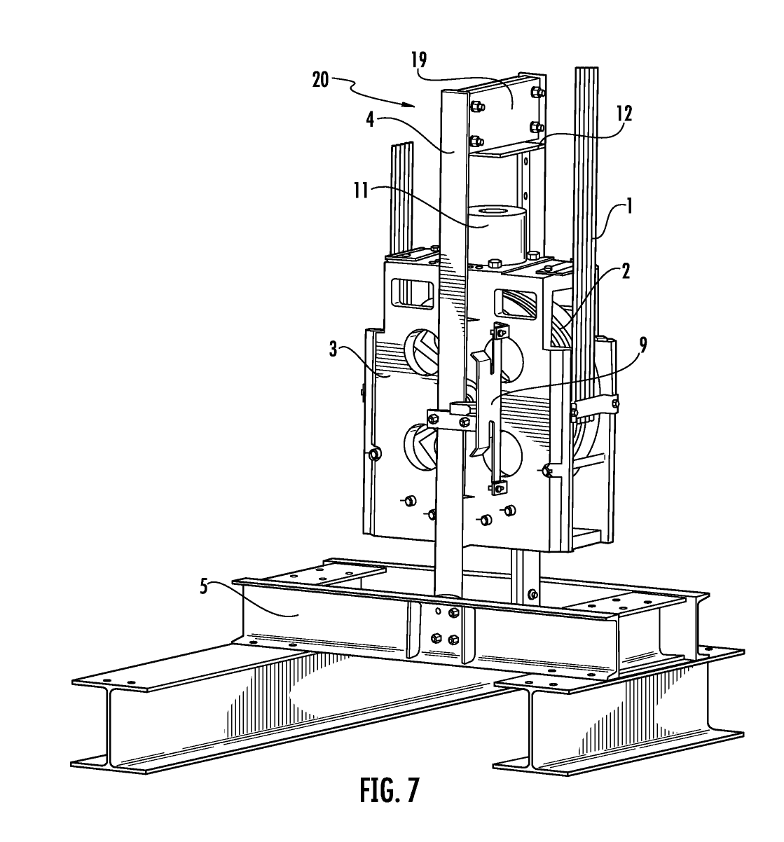

FIG. 6 is a schematic view of the limiting mechanism for an elevator compensation rope tensioning pulley 10 shown in FIG. 2 being in a collided state. As can be seen from FIG. 6, in a collided state, compared with a normal working state, the tensioning pulley 2, the tensioning pulley frame 3, and the rubber pad 11 move upward, and the lead screw 16 protrudes from above the fixing plate 12. The pawl 141 is held against the ratchet on the ratchet rack 142 of the guiderail, to prevent the fixing plate 12 from moving upward. The rubber pad 11 collides with the fixing plate 12 and is stopped at the fixing plate 12. In this case, because the guiderail 4 is fixed in the pit of the elevator shaft way, a phenomenon in which the compensation rope tensioning pulley 2 and the frame 3 rush upward is prevented.

FIG. 7 is a schematic view of another embodiment of an elevator compensation apparatus according to the present invention. For a compensation rope 1, a tensioning pulley 2, a tensioning pulley frame 3, a guiderail 4, and an elevator compensation apparatus base 5 in the embodiment, reference may be made to the description of the foregoing embodiments. In addition, although not shown, to laterally support the guiderail 4 to improve stability, in this embodiment, reference may also be made to the description of the foregoing embodiments, in which the tensioning pulley guiderail 4 is connected to a guiderail support 6 of an elevator counterweight guiderail and the like. A limiting mechanism 20 located above the tensioning pulley frame is specifically described below, that is, the portion in the circle in FIG. 7.

In the elevator compensation apparatus in this embodiment shown in the FIG., the limiting mechanism 20 includes a pad block. For example, a rubber pad 11 is used as a first limiting component, and a rigid fixing plate 12 is used as a second limiting component. The rubber pad 11, the tensioning pulley 2, and the frame 3 of the tensioning pulley 2 are suspended on a tensioning rope 1, and the fixing plate 12 is fixed on the guiderail 4. A vertical distance within a predetermined range is kept in a longitudinal direction between the rubber pad 11 and the rigid fixing plate 12.

As shown in the FIG., the rubber pad 11 is disposed on the frame 3 of the tensioning pulley 2, and the rubber pad 11, the tensioning pulley 2, and the frame 3 are together kept in position by a tensioning force of an elevator compensation rope, that is, are suspended on the compensation rope. To make the positioning of the rubber pad more stable, the rubber pad may be fixed to the frame, for example, fixed by using a bolt and the like. In this embodiment, considering the limit of an area of the elevator shaft way, the rubber pad 11 is optionally positioned on the top of the frame 3 between two guiderails 4, and can directly collide with the fixing plate 12 when the tensioning pulley 2 rushes upward. It may be conceived that, in another optional embodiment, the rubber pad 11 may also be disposed at another suitable position, corresponding to the fixing plate 12, of the frame 3.

For example rather than to cause any limitation, a person skilled in the art can select a collision contact area, a thickness, and an elasticity of the rubber pad 11 that are suitable for cushioning impact caused when the rubber pad 11 and the fixing plate 12 collide with each other. The rubber pad 11 may have a columnar shape, and optionally have a cylindrical shape, a prismatic shape or the like. A person skilled in the art may make a variation to the specific implementation form of the rubber pad 11 with reference to the related description of the foregoing embodiment.

According to the concept of the present invention, the fixing plate 12 is limited at a suitable position relative to the guiderail 4 of the elevator compensation rope tensioning pulley 2, and a vertical distance within a predetermined range is kept between the rubber pad 11 and the fixing plate 12. When an upward displacement of the elevator compensation rope tensioning pulley 2 reaches the vertical distance, the rubber pad 11 collides with the fixing plate 12 to limit the elevator compensation rope tensioning pulley 2 to make the elevator compensation rope tensioning pulley 2 stop moving upward.

Specifically, in the embodiment shown in the FIG., the fixing plate 12 is located above the rubber pad 11, and a reinforcing beam 19 that is fixed to the guiderail 4 and is parallel to the fixing plate 12 is further disposed above the rubber pad 11. The reinforcing beam 19 may be coupled and fixed on the guiderail 4 by using a bolt, so as to determine the positions of the reinforcing beam 19 and the fixing plate 12 on the guiderail. As can be seen from FIG. 7, multiple installation holes arranged in a longitudinal direction are formed on an inner side surface of the guiderail 4, so that the fixing plate 12 is longitudinally adjustable relative to a limiting position of the guiderail. These installation holes may be blind holes or may be through holes. By fixing the reinforcing beam inside installation holes at different heights, the distance between the fixing plate 12 and the rubber pad 11 may be adjusted.

According to a specific case, in a case in which the strength of the fixing plate 12 is sufficiently large, the fixing plate 12 may also be directly coupled and fixed on the guiderail 4 by using a bolt. In this case, if the position of the fixing plate needs to be adjusted, the fixing plate 12 may be directly fixed inside installation holes at a different height of the guiderail 4. According to the teaching of the present invention, a person skilled in the art may conceive that the fixing plate 12 is installed on the guiderail 4 in a manner other than a bolt coupling.

Similarly, in this embodiment, the solution in which the rubber pad is used as the first limiting component is also exemplary. A person skilled in the art may think of using a rigid first limiting component and a rigid second limiting component; however, on at least one of the first limiting component and the second limiting component, an elastic cushioning material may be at least disposed at a position where the first limiting component and the second limiting component are to collide. For the elastic cushioning material, reference may also be made to the specific description of the foregoing embodiment.

In an optional embodiment, to reduce the weight or save materials, one or more through holes may be disposed in the rubber pad. More beneficially, cushioning components such as coil springs may be disposed in these through holes, and these cushioning components may provide a cushioning effect before the rubber pad collides with the fixing plate, so as to provide protection and reduce collision impact for related components. These through holes can provide external guidance for the springs, and during operation, ensure the lateral stability of the springs. Guiding rods may be further disposed inside the springs to provide internal guidance for the springs. In this case, considering that the fixing plate in this embodiment is located at a fixed position relative to the guiderail after installation is complete, to enable the tensioning pulley and the frame to follow the compensation rope to move downward when the compensation rope is tensioned, an adjusting nut is not needed on the guiding rod. To prevent the tensioning pulley from becoming too low, in the embodiment, the position-limiting mechanism 9 also needs to be disposed. For the position-limiting mechanism 9, reference may also be made to the description of the embodiments.

It may be understood that according to the foregoing teaching of the present invention, a person skilled in the art can conceive that a cushioning component in another form is used to provide a cushioning effect in a longitudinal direction before the rubber pad collides with the fixing plate. For example rather than to cause any limitation, a through hole may be formed at an intermediate portion of the rubber pad, and a hydraulic cylinder vertically disposed through the through hole is chosen as the cushioning component. A cylinder block of the hydraulic cylinder may be fixed on the frame, a top end of a piston of the hydraulic cylinder needs to be higher than the rubber pad and needs to abut the fixing plate when the hydraulic cylinder provides a cushioning effect. Because the fixing plate is fixed relative to the guiderail, the top end of the piston cannot be fixed on the fixing plate.

By means of the foregoing teaching of the elevator compensation apparatus and the limiting mechanism for the elevator compensation apparatus, a person skilled in the art may obtain an elevator system that includes these apparatuses or mechanisms according to the present invention. It may be conceived that, the elevator system according to the present invention may have other functional components of an elevator in the prior art, and details are no longer described herein.

The foregoing description of the optional embodiments of the present invention according to the accompanying drawings are merely exemplary and descriptive. With the teaching herein, a person skilled in the art can also make equivalent or similar forms of variations or modifications to the optional embodiments of the present invention, and these variations or modifications also fall within the protection scope covered by the claims of the present invention.

1. A limiting mechanism for an elevator compensation rope tensioning pulley, wherein the limiting mechanism comprises:
a first limiting component, disposed on a frame of an elevator compensation rope tensioning pulley, and kept in position by a tensioning force of an elevator compensation rope together with the elevator compensation rope tensioning pulley and the frame; and
a second limiting component, limited at a suitable position relative to a guiderail of the elevator compensation rope tensioning pulley,
wherein a vertical distance within a predetermined range is kept between the first limiting component and the second limiting component, and, when an upward displacement of the elevator compensation rope tensioning pulley reaches the vertical distance, the first limiting component collides with the second limiting component to limit the elevator compensation rope tensioning pulley to make the elevator compensation rope tensioning pulley stop moving upward.

2. The limiting mechanism according to claim 1, wherein the second limiting component is longitudinally adjustable relative to a limiting position of the guiderail.

3. The limiting mechanism according to claim 1, wherein the first limiting component is positioned at the top of the frame, and the second limiting component is located above the first limiting component.

4. The limiting mechanism according to claim 1, wherein an elastic cushioning material is disposed on at least one of the first limiting component and the second limiting component at least at a position where the first limiting component and the second limiting component are to collide.

5. The limiting mechanism according to claim 3, wherein the first limiting component is a rubber pad, and the second limiting component is a rigid fixing plate.

6. The limiting mechanism according to claim 5, wherein the rubber pad has a columnar shape, and optionally has a cylindrical shape or a prismatic shape, and a collision contact area, a thickness, and an elasticity of the rubber pad are suitable for cushioning impact caused when the rubber pad and the rigid fixing plate collide with each other.

7. The limiting mechanism according to claim 1, wherein a pawl assembly is disposed on the second limiting component, and comprises a pawl with an upward end, a ratchet rack is formed on a lateral portion of the guiderail, and the pawl is biased on a tooth back of a ratchet on the ratchet rack; and
the limiting mechanism further has a distance keeping component, wherein when the elevator compensation rope tensioning pulley moves downward, the distance keeping component keeps the vertical distance between the first limiting component and the second limiting component.

8. The limiting mechanism according to claim 7, wherein the distance keeping component is a compression spring sandwiched between the frame and the second limiting component.

9. The limiting mechanism according to claim 8, wherein a through hole is formed at an intermediate portion of the first limiting component, the compression spring is a coil spring vertically disposed through the through hole, and an upper end and a lower end of the coil spring are respectively held against the second limiting component and the frame.

10. The limiting mechanism according to claim 9, wherein a lead screw is vertically disposed inside the coil spring, and a lower end of the lead screw is fixed on the frame; and
a penetrating hole corresponding to the lead screw is disposed in the second limiting component, and the lead screw extends and passes through the penetrating hole and is slidable longitudinally relative to the penetrating hole.

11. The limiting mechanism according to claim 10, wherein an spacing washer for keeping the lead screw and the second limiting component from contacting each other is sleeved inside the penetrating hole.

12. The limiting mechanism according to claim 10, wherein an upper end of the lead screw is joined with an adjusting nut, the adjusting nut is held downward against the second limiting component, and a longitudinal displacement of the adjusting nut along the lead screw is suitable for adjusting the vertical distance.

13. The limiting mechanism according to claim 7, wherein the distance keeping component is a hydraulic cylinder, a cylinder block of the hydraulic cylinder is fixed to the frame, and a piston of the hydraulic cylinder is fixed to the second limiting component.

14. The limiting mechanism according to claim 7, wherein the pawl assembly further comprises a pawl base, a pivot shaft, and a torsion spring, the pawl base is fixed on the second limiting component, the pivot shaft is transversely mounted on the pawl base, the pawl is sleeved over the pivot shaft in a pivotal manner, and the torsion spring is sheathed on the pivot shaft and biases the pawl.

15. The limiting mechanism according to claim 14, wherein a quantity of the pawl bases is two, the two pawl bases are respectively located on two sides of the pawl, and the pivot shaft is mounted on the two pawl bases.

16. The limiting mechanism according to claim 7, wherein a quantity and positions of the pawls correspond to a quantity and positions of ratchet racks on the guiderail.

17. The limiting mechanism according to claim 16, wherein a quantity of the pawls is two.

18. The limiting mechanism according to claim 1, wherein the second limiting component is coupled and fixed on the guiderail by using a bolt.

19. The limiting mechanism according to claim 18, wherein a cushioning component is disposed on the frame, and the cushioning component provides a longitudinal cushioning effect before the first limiting component collides with the second limiting component.

20. The limiting mechanism according to claim 19, wherein a through hole is formed at an intermediate portion of the first limiting component, and the cushioning component is a coil spring vertically disposed through the through hole.

21. The limiting mechanism according to claim 18, wherein a guiding component for guiding an upward direction of the frame and the first limiting component is disposed between the frame and the second limiting component.

22. The limiting mechanism according to claim 19, wherein a through hole is formed at an intermediate portion of the first limiting component, and the cushioning component is a hydraulic cylinder vertically disposed through the through hole, wherein a cylinder block of the hydraulic cylinder is fixed on the frame, and a top end of a piston of the hydraulic cylinder is higher than the first limiting component and abuts the second limiting component when the cushioning effect is provided.

23. The limiting mechanism according to claim 18, wherein a reinforcing beam fixed to the guiderail and parallel to the second limiting component is disposed above the second limiting component.

24. An elevator compensation apparatus, wherein the elevator compensation apparatus comprises an elevator compensation rope and an elevator compensation rope tensioning pulley, and the elevator compensation rope tensioning pulley is installed inside a frame of the elevator compensation rope tensioning pulley, and
the elevator compensation apparatus further comprises a limiting mechanism for an elevator compensation rope tensioning pulley according to claim 1.

25. An elevator system, wherein the elevator system comprises an elevator compensation apparatus according to claim 24.
